(19) United States
(12) Patent Application Publication
(10) Pub. No.: US 2012/0279495 A1
(43) Pub. Date: Nov. 8, 2012

(54) SOLID-ACID-CATALYZED SACCHARIFICATION DEVICE AND METHOD

(76) Inventors: Makoto Kitano, Tokyo (JP); Kenji Sato, Fujisawa-shi (JP); Kentaro Nariai, Yokohama-shi (JP); Tatsuya Oka, Yokohama-shi (JP); Michikazu Hara, Yokohama-shi (JP); Daizo Yamaguchi, Tsuyama-shi (JP)

(21) Appl. No.: 13/521,630

(22) PCT Filed: Jan. 18, 2011
(86) PCT No.: PCT/JP2011/050755

§ 371 Date: Jul. 11, 2012

(30) Foreign Application Priority Data
Jan. 18, 2010 (JP) P2010-008552

(51) Int. Cl. C13K 13/00; B01J 19/18

(52) U.S. Cl. 127/1; 127/36

(57) ABSTRACT

A solid-acid-catalyzed saccharification device (A) includes a catalytic reaction vessel (3) configured to contain a polysaccharide feedstock with water and a solid-acid catalyst (X2) as a liquid mixture (X3) to monosaccharify the polysaccharide using the solid-acid catalyst (X2), an agitation device (4) configured to agitate the liquid mixture (X3) in the catalytic reaction vessel (3), an oxidation-reduction electrometer (5) configured to measure the redox potential of the liquid mixture (X3) in the catalytic reaction vessel (3), and a pH meter (6) configured to measure the pH of the liquid mixture (X3) in the catalytic reaction vessel (3). According to the solid-acid-catalyzed saccharification device (A), it is possible to accurately follow the reaction state of a saccharification process of a feedstock using a solid acid catalyst.

### TECHNICAL FIELD

The present invention relates to a solid-acid-catalyzed saccharification device and method.

This application claims priority to and the benefit of Japanese Patent Application No. 2010-8552 filed on Jan. 18, 2010, the disclosure of which is incorporated by reference herein.

### BACKGROUND ART

As is well known, recently, technology for generating ethanol (bioethanol) using a biomass (a biogenous organic resource excluding fossil resources) as a substitute fuel for fossil fuels such as petroleum has been drawing attention. In the following Non-Patent Document 1, technology for saccharifying the biomass using a solid-acid catalyst is disclosed as elemental technology in the manufacturing process of such bioethanol.

In this saccharification technology of the biomass, a cellulose-based biomass is decomposed and saccharified by combining a hydrothermal reaction with a catalyst (a solid-acid catalyst) having a sulfo group supported in a carrier such as carbon or zeolite. As the saccharification technology of the biomass, a method of hydrolyzing by adding sulfuric acid to the biomass is generally known. But, this method has a problem that the reactor corrodes or waste solution treatment becomes necessary by using sulfuric acid as a liquid. Such a problem with the method of using sulfuric acid (liquid) can be overcome by the above-mentioned method of using the acid-solid catalyst.

On the other hand, although the solid-acid catalyst and the hydrothermal reaction are combined in the technology of Non-Patent Document 1, the technology for saccharifying the biomass using the solid-acid catalyst singly has been studied.

### PRIOR ART DOCUMENT

### Non-Patent Document

[Non-Patent Document 1] Seminar text “The pretreatment and saccharification of biomass oriented for the manufacture of ethanol fuels” (Technical Information Institute Co., Ltd) (2009)

### SUMMARY OF THE INVENTION

### Problems to be Solved by the Invention

However, the saccharification of biomass using the solid-acid catalyst is a reaction of decomposing the biomass into a monosaccharide, in which the solid-acid catalyst which is a solid acts on the biomass which is a solid as well. That is, since it is a reaction in which a solid (a solid-acid catalyst) acts on a solid (a biomass), the reaction speed is slow. Thus, there is a problem that it is difficult to accurately follow the reaction state in a reaction vessel. Especially, in the case of using the solid-acid catalyst singly, the reaction speed is remarkably slow, and thus it is significantly difficult to accurately follow the reaction state. Therefore, when the saccharification technology of the biomass using the solid-acid catalyst is applied to the bioethanol manufacturing process, it is impossible to accurately follow the reaction state of the biomass saccharification process, and it is thus impossible to accurately control the operation of the whole system.

In consideration of the above-mentioned circumstances, it is an object of the present invention to accurately follow the reaction state of a saccharification process of a feedstock using a solid-acid catalyst.

### Means for Solving the Problems

In order to accomplish the above object, a solid-acid-catalyzed saccharification device according to the present invention includes a catalytic reaction vessel configured to contain a polysaccharide feedstock with water and a solid-acid catalyst as a liquid mixture to monosaccharify a polysaccharide using the solid-acid catalyst, an agitation device configured to agitate the liquid mixture in the catalytic reaction vessel, an oxidation-reduction electrometer configured to measure a redox potential of the liquid mixture in the catalytic reaction vessel, and a pH meter configured to measure the pH of the liquid mixture in the catalytic reaction vessel.

Further, in the solid-acid-catalyzed saccharification device, the device may include a catalyst separation vessel configured to separate the solid-acid catalyst from a treated solution received from the catalytic reaction vessel, a catalyst conveying device configured to supply the solid-acid catalyst discharged from the catalyst separation vessel to the catalytic reaction vessel, a second oxidation-reduction electrometer configured to measure a redox potential of a solution from which the solid-acid catalyst in the treated solution is separated in the catalyst separation vessel, and a second pH meter configured to measure the pH of the solution from which the solid-acid catalyst in the treated solution is separated in the catalyst separation vessel.

Further, in the solid-acid-catalyzed saccharification device, the agitation device may agitate the solution to be treated by rotating a paddle immersed in the liquid mixture.

Further, in the solid-acid-catalyzed saccharification device, the agitation device may agitate the solution to be treated by blowing gas into the liquid mixture.

In addition, a solid-acid-catalyzed saccharification method according to the present invention includes measuring a redox potential and a pH of a liquid mixture of a solution to be treated and a solid-acid catalyst at the time of monosaccharification of a polysaccharide by acting the solid-acid catalyst on the solution to be treated including water and a polysaccharide feedstock, and evaluating a monosaccharification state based on the redox potential and the pH.

Further, in the solid-acid-catalyzed saccharification method, the method may include measuring a redox potential and a pH of a solution from which the solid-acid catalyst in the treated solution is separated, and evaluating a state of the solid-acid catalyst based on the redox potential and the pH.

### Effect of the Invention

According to the present invention, the redox potential and the pH of the solution to be treated are measured at the time of monosaccharification treatment of the polysaccharide using the solid-acid catalyst, so that it is possible to evaluate the state of monosaccharification treatment by the respective measurement values of redox potential and the pH.

That is, according to the knowledge of the present inventors, in terms of the reaction in which the polysaccharide is monosaccharified, differences occur in the redox potential between the good state and the bad state of reactions. The pH shows the active state of the solid-acid catalyst.

Therefore, it is possible to accurately follow the state of monosaccharification of the polysaccharide in the case of using the solid-acid catalyst by measuring the pH of the solution to be treated in addition to the redox potential of the solution to be treated.

### BRIEF DESCRIPTION OF THE DRAWINGS

FIG. 1 is a block diagram showing the function and configuration of a solid-acid-catalyzed saccharification device according to an embodiment of the present invention.

FIG. 2 is a block diagram showing the function and configuration of a solid-acid-catalyzed saccharification device according to a modified example of an embodiment of the present invention.

### MODES FOR CARRYING OUT THE INVENTION

Hereinafter, example embodiments of the present invention will be described in detail with reference to the accompanying drawings.

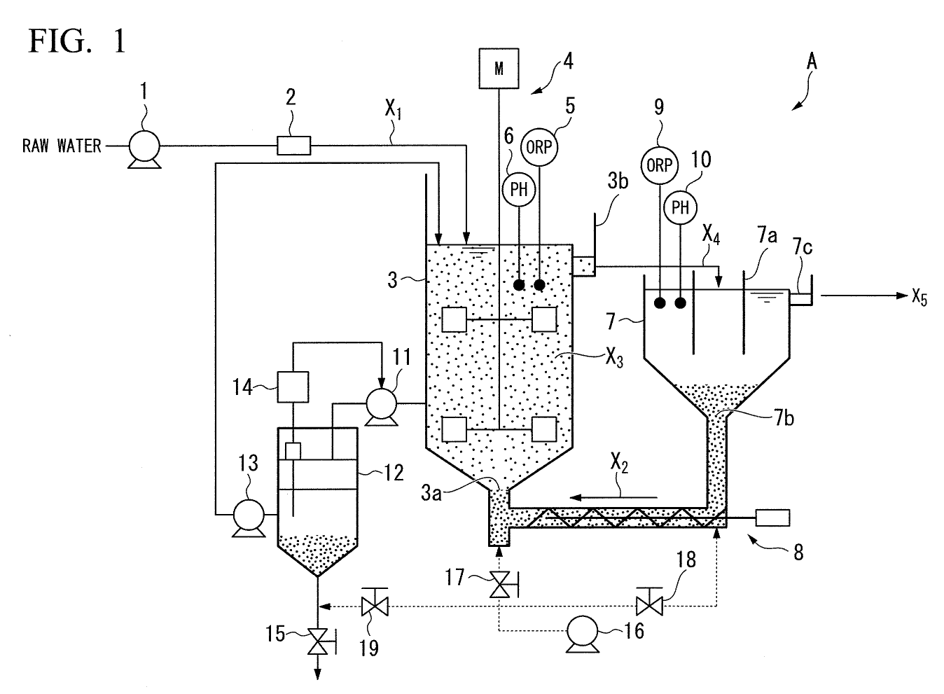

As shown in FIG. 1, a solid-acid-catalyzed saccharification device A according to an embodiment of the present invention includes a raw water-supplying pump 1, a flow meter 2, a catalytic reaction vessel 3, an agitation device 4, an oxidation-reduction electrometer 5, a pH meter 6, a catalyst separation vessel 7, a catalyst conveying device 8, a second oxidation-reduction electrometer 9, a second pH meter 10, a catalyst recovery pump 11, a catalyst recovery vessel 12, a solution-conveying pump 13, a float switch 14, a catalyst discharge valve 15, a blockage-preventing gas blower 16, and on-off valves 17 to 19.

The solid-acid-catalyzed saccharification device A is a device for monosaccharifying a feedstock (a polysaccharide) supplied from the outside. Such a solid-acid-catalyzed saccharification device A functions as a latter-stage saccharification device for, for example, monosaccharifying the polysaccharide obtained from a biomass by a former-stage saccharification device in a plant for manufacturing biomethanol from the biomass (the biogenous resource excluding fossil resources). As the former-stage saccharification device, for example, a hot water-flowing type saccharification device to polysaccharify the biomass by circulating hot water of a predetermined temperature for a predetermined time in a granular biomass filled in a tubular reaction device may be considered.

The present applicant proposed a biomass treatment device and method in Japanese Patent Application No. 2009-219362 (filed on Sep. 24, 2009, title of invention: Biomass Treatment Device and Method), in which xylooligosaccharide and cellooligosaccharide are obtained individually from polysaccharides (carbohydrates) contained in a biomass (a wood-based biomass) by adjusting a hot-water temperature in a hot compressed water reaction device (a former-stage saccharification device); xylooligosaccharide is treated by a first catalytic reaction device (a latter-stage saccharification device) to monosaccharify the xylooligosaccharide to xylose (C₅H₁₀O₅: pentose); cellooligosaccharide is treated by a second catalytic reaction device (a latter-stage saccharification device) to monosaccharify the cellooligosaccharide to glucose (C₆H₁₂O₆: hexose); and further bioethanol (C₂H₆O) is manufactured by fermentation treatment of xylose with a first fermentation device, and by fermentation treatment of glucose with a second fermentation device.

As is well known, the main components of the wood-based biomass are cellulose (polysaccharide), hemicellulose (polysaccharide) and lignin. By acting hot water on the wood-based biomass of such components, it is possible to further decompose cellulose or hemicelluloses into polysaccharides with a lower degree of polymerization (xylooligosaccharide, cellooligosaccharide and various oligosaccharides with the degree of polymerization slightly higher than these). The solid-acid-catalyzed saccharification device A has basic functions equivalent to the above-mentioned first and second catalytic reaction devices, and takes in water-mixed granular polysaccharide from the former-stage saccharification device (the hot-water flow-type saccharification device) as raw water X1 (solution to be treated) and monosaccharifies the feedstock to xylose or glucose.

By the raw water-supplying pump 1 in the solid-acid-catalyzed saccharification device A, the raw water X1 is supplied sequentially and continually at a predetermined flow rate to the catalytic reaction vessel 3. The flow meter 2 is installed in the middle of a pipe connecting the raw water-supplying pump 1 and the catalytic reaction vessel 3 to measure the supply flow rate of the raw water X1.

In the catalytic reaction vessel 3, solid-acid catalyst X2 is used on the raw water X1 to monosaccharify the polysaccharide. This catalytic reaction vessel 3 is a cylindrical container for containing a predetermined amount of raw water X1 and is installed in an attitude with a central axis being in the vertical direction, as shown in the drawing. In the bottom portion of the catalytic reaction vessel 3, a catalyst intake portion 3a for taking in the granular solid-acid catalyst X2 is formed, and on the upper peripheral edge of the catalytic reaction vessel 3, an outlet 3b for discharging a treated solution X4 is formed. That is, the solution stored in the catalytic reaction vessel 3 is a liquid mixture X3 in which the granular solid-acid catalyst X2 is mixed in the raw water X1.

As shown in the drawing, the agitation device 4 rotates a paddle (an agitating blade), which is fixed perpendicularly to the rotation axis and immersed in the liquid mixture X3 of the catalytic reaction vessel 3, by a motor at a predetermined speed to agitate the liquid mixture X3 in the catalytic reaction vessel 3. The paddle of the agitation device 4 is installed in two stages on the rotation axis to mix the liquid mixture X3 in the cylindrical catalytic reaction vessel 3 uniformly without being dispersed ununiformly between the top and bottom positions, as shown in drawing. But, if the height of top and bottom increases, multi-stages of three or more stages are preferable. By the agitation of the liquid mixture X3 by the agitation device 4, the solid-acid catalyst X2 can be dispersed uniformly into the raw water X1 in the catalytic reaction vessel 3.

The oxidation-reduction electrometer 5 measures the redox potential of the liquid mixture X3 in the catalytic reaction vessel 3. The pH meter 6 measures the pH of the liquid mixture X3 in the catalytic reaction vessel 3. The redox potential, as is well known, shows different values by types of chemical reactions, and by the equilibrium state (progress state) of chemical reactions. In addition, the active state of the solid-acid catalyst X2 as a catalyst appears as the pH (hydrogen ion exponent) of the liquid mixture X3.

The present inventors discovered that there are differences in redox potential and the pH between the good state and the bad state of reactions in which the polysaccharide in the liquid mixture X3 in the catalytic reaction vessel 3 is monosaccharified. Thereby, the oxidation-reduction electrometer 5 and the pH meter 6 are characteristic elements in the solid-acid-catalyzed saccharification device A for following the state of the decomposition reaction from polysaccharides into monosaccharides in the catalytic reaction vessel 3, that is, the state of the decomposition reaction for monosaccharifying polysaccharides in the liquid mixture X3 using the solid-acid catalyst X2.

Further, the redox potential has dependency on the pH of the reaction system as is well known, so the measurement values of the pH meter 6 are utilized effectively also to accurately evaluate the measurement values of the oxidation-reduction electrometer 5. In addition, though not shown in the drawing, performing the evaluation of the state of the decomposition reaction based on the measurement values of the oxidation-reduction electrometer 5 and the measurement values of the pH meter 6 automatically and objectively using an information processing device (a computer) equipped with a program dedicated to evaluation may be considered.

The catalyst separation vessel 7 is a precipitation vessel for separating the solid-acid catalyst X2 from the treated solution X4 received from the catalytic reaction vessel 3. This catalyst separation vessel 7 is, as shown in drawing, a cylindrical container for containing a predetermined amount of the treated solution X4, and is installed in an attitude with the central axis in the vertical direction. In the top center of the catalyst separation vessel 7, a cylindrical member 7a for receiving the treated solution X4 is installed with a perpendicular attitude as shown in drawing, and in the bottom portion of the catalyst separation vessel 7, a catalyst outlet 7b for discharging a precipitated granular solid-acid catalyst X2 is formed. Further, on the upper peripheral edge of the catalyst separation vessel 7, a treated water outlet 7c for discharging a solution from which the solid-acid catalyst X2 in the treated solution X4 is separated as treated water X5 is formed.

The catalyst conveying device 8 is a screw conveyor as shown in drawing, and supplies the solid-acid catalyst X2 discharged from the catalyst outlet 7b to the catalyst intake portion 3a. The second oxidation-reduction electrometer 9 measures the redox potential of the supernatant liquid, that is, the treated water X5 in the catalyst separation vessel 7. The second pH meter 10 measures the pH of the supernatant liquid, that is, the treated water X5 in the catalyst separation vessel 7. The second oxidation-reduction electrometer 9 and the second pH meter 10 are for evaluating the property of the treated water X5 and the active state of the solid-acid catalyst X2. In addition, although not shown in drawing, evaluating the property of the treated water X5 and the active state of the solid-acid catalyst X2 based on these measurement values of the second oxidation-reduction electrometer 9 and the second pH meter 10 automatically and objectively using an information processing device (a computer) equipped with a program dedicated to evaluation may be considered.

The catalyst recovery pump 11 delivers a part of the liquid mixture X3 from the catalytic reaction vessel 3 and supplies the part of the liquid mixture X3 to the catalyst recovery vessel 12. The catalyst recovery vessel 12 is a container for temporarily storing the liquid mixture X3 supplied from the catalyst recovery pump 11, and separates the solid-acid catalyst X2 from the liquid mixture X3 and discharges the solid-acid catalyst X2 from the bottom portion thereof The solution-conveying pump 13 conveys the solution (i.e. the raw water X1 treated to some extent by the solid-acid catalyst X2), from which the solid-acid catalyst X2 in the liquid mixture X3 is separated, from the catalyst recovery vessel 12 to the catalytic reaction vessel 3.

The float switch 14 is a mechanical switch operated according to a liquid level of the catalyst recovery vessel 12, and turns the operation of the catalyst recovery pump 11 on/off. That is, if the liquid level of the catalyst recovery vessel 12 is below a predetermined value, the float switch 14 is turned on to operate the catalyst recovery pump 11. The catalyst discharge valve 15 is an on-off valve installed on the bottom portion of the catalyst recovery vessel 12, and turns the discharge of the solid-acid catalyst X2 from the catalyst recovery vessel 12 on/off.

The blockage-preventing gas blower 16 is a pump for supplying compressed air such that a pipe can be prevented from being blocked due to the solid-acid catalyst X2. As shown in the drawing, the pipe communicates with the catalyst intake portion 3a, the catalyst conveying device 8 and the bottom portion of the catalyst recovery vessel 12. The on/off valve 17 is installed between the blockage-preventing gas blower 16 and the catalyst intake portion 3a, the on/off valve 18 is installed between the blockage-preventing gas blower 16 and the catalyst conveying device 8, and the on/off valve 19 is installed between a pipe communicating with the bottom portion of the catalyst recovery vessel 12 and the blockage-preventing gas blower 16.

Next, a saccharification method using the acid-solid-catalyzed saccharification device A configured as described above will be described in detail.

In the solid-acid-catalyzed saccharification device A, the raw water X1 is supplied to the catalytic reaction vessel 3 by the raw water-supplying pump 1 sequentially and continually at a predetermined flow rate. The raw water X1 stays for a certain time in the catalytic reaction vessel 3 in a state mixed with the solid-acid catalyst X2, that is, as the liquid mixture X3. Granular polysaccharides contained in the raw water X1 are monosaccharified by the catalytic action of the solid-acid catalyst X2 while staying in the catalytic reaction vessel 3. The treated solution X4 after monosaccharification is discharged as the supernatant liquid from the outlet 3b formed on the upper peripheral edge of the catalytic reaction vessel 3, and is supplied into the cylindrical member 7a of the catalyst separation vessel 7.

Such a progress state of the decomposition reaction of the polysaccharides into monosaccharides in the catalytic reaction vessel 3 is monitored by the oxidation-reduction electrometer 5 and the pH meter 6. That is, the redox potential values, which are the measurement results of the oxidation-reduction electrometer 5, show the progress state of the decomposition reaction, and the pH values, which are the measurement results of the pH meter 6, show the concentration of hydrogen ions according to the decomposition reaction.

For instance, if the polysaccharides contained in raw water X1 have cellooligosaccharide as a main component, cellooligosaccharide is decomposed into glucose by the catalytic action of the solid-acid catalyst X2 in the catalytic reaction vessel 3. However, if this decomposition reaction progresses normally, the redox potential values become smaller than −1100 (mV vs. SHE). If the liquid mixture X3 in the catalytic reaction vessel 3 shows pH values smaller than 4.0, the solid-acid catalyst X2 shows sufficient catalytic reaction as an acid.

Therefore, when the measurement values output from the oxidation-reduction electrometer 5 are less than −1100 (mV vs. SHE) and the measurement values output from the pH meter 6 are less than 4.0, the decomposition reaction can be evaluated as progressing smoothly in the catalytic reaction vessel 3. In contrast to this, when the measurement values output from the oxidation-reduction electrometer 5 are −1100 (mV vs. SHE) or more and the measurement values output from the pH meter 6 are 4.0 or more, the decomposition reaction in the catalytic reaction vessel 3 can be determined as being in a bad state for some reason.

In the solid-acid-catalyzed saccharification device A, as mentioned above, the treated solution X4 is supplied sequentially and continually from the catalytic reaction vessel 3 into the cylindrical member 7a of the catalyst separation vessel 7. In the catalyst separation vessel 7, a solution from which the solid-acid catalyst X2 in the treated solution X4 is separated, that is, a supernatant liquid containing only monosaccharides, is discharged from the treated water outlet 7c as treated water X5 (a product). Meanwhile, the solid-acid catalyst X2 recovered into the catalyst separation vessel 7 is conveyed sequentially to the catalytic reaction vessel 3 from the catalyst outlet 7b by the catalyst conveying device 8. By the circulation of the solid-acid catalyst X2 between the catalytic reaction vessel 3 and the catalyst separation vessel 7, the concentration of the solid-acid catalyst X2 in the catalytic reaction vessel 3 is maintained almost constant.

Maintaining operation of the solid-acid-catalyzed saccharification device A gradually lowers the activity of the solid-acid catalyst X2. Also in this case, since the redox potential of the supernatant liquid in the catalyst separation vessel 7, that is, the treated water X5, is measured by the second oxidation-reduction electrometer 9, and the pH of the treated water X5 is measured by the second pH meter 10, it is possible to accurately evaluate the property of the treated water X5 and the active state of the solid-acid catalyst X2.

For instance, if the polysaccharide contained in the raw water X1 has cellooligosaccharide as a main component, the treated water X5 mainly contains glucose. However, the redox potential values whereby it can be said that the property of such treated water X5 is in a favorable state are in the range below −900 (mV vs. SHE). In addition, if the treated water X5 shows a pH value smaller than 5.0, it can be said that the solid-acid catalyst X2 is in a sufficient active state as an acid.

When it is confirmed that the activity of the solid-acid catalyst X2 is lowered to a certain extent based on the measurement values output from the second pH meter 10, the catalyst recovery pump 11 starts operating to begin recovery of the solid-acid catalyst X2 in the catalytic reaction vessel 3 into the catalyst recovery vessel 12. The catalyst recovery pump 11, when it starts operating like this, recovers the liquid mixture X3 from the catalytic reaction vessel 3 based on the control by the float switch 14. Here, since the concentration of the solid-acid catalyst X2 in the catalytic reaction vessel 3 is lowered by the recovery of the solid-acid catalyst X2 into the catalyst recovery vessel 12, the solid-acid catalyst X2 of a new product is supplied in addition to the catalytic reaction vessel 3 so as to supplement this recovered the solid-acid catalyst X2.

When the solid-acid catalyst X2 is separated from the liquid mixture X3 recovered into the catalyst recovery vessel 12 from the catalytic reaction vessel 3, the separated solid-acid catalyst X2 is recovered through the catalyst discharge valve 15. Meanwhile, the solution from which the solid-acid catalyst X2 is separated is returned to the catalytic reaction vessel 3 by the solution-conveying pump 13. In addition, the pipe communicating with the catalyst intake portion 3a, the catalyst conveying device 8 and the bottom portion of the catalyst recovery vessel 12 has a possibility of being blocked with the granular solid-acid catalyst X2 passing therethrough. However, such blockage can be prevented effectively since the compressed air is supplied from the blockage-preventing gas blower 16.

As described above, according to this embodiment, it is possible to accurately evaluate the progress state of the decomposition reaction from the polysaccharides into monosaccharides that occurs in the catalytic reaction vessel 3, since the redox potential of the liquid mixture X3 in the catalytic reaction vessel 3 is measured by the oxidation-reduction electrometer 5, and the pH of the liquid mixture X3 in the catalytic reaction vessel 3 is measured by the pH meter 6.

In addition, the present invention is not limited to the above-mentioned embodiment. For example, modified examples shown below may be considered.

(1) The above-mentioned embodiment adopts the agitation device 4 that rotates a paddle (an agitating blade), which is fixed perpendicularly to the rotation axis and immersed in the liquid mixture X3 of the catalytic reaction vessel 3, by a motor at a predetermined speed to agitate the liquid mixture X3 in the catalytic reaction vessel 3. However, the configuration of the agitation device 4 is not limited thereto.

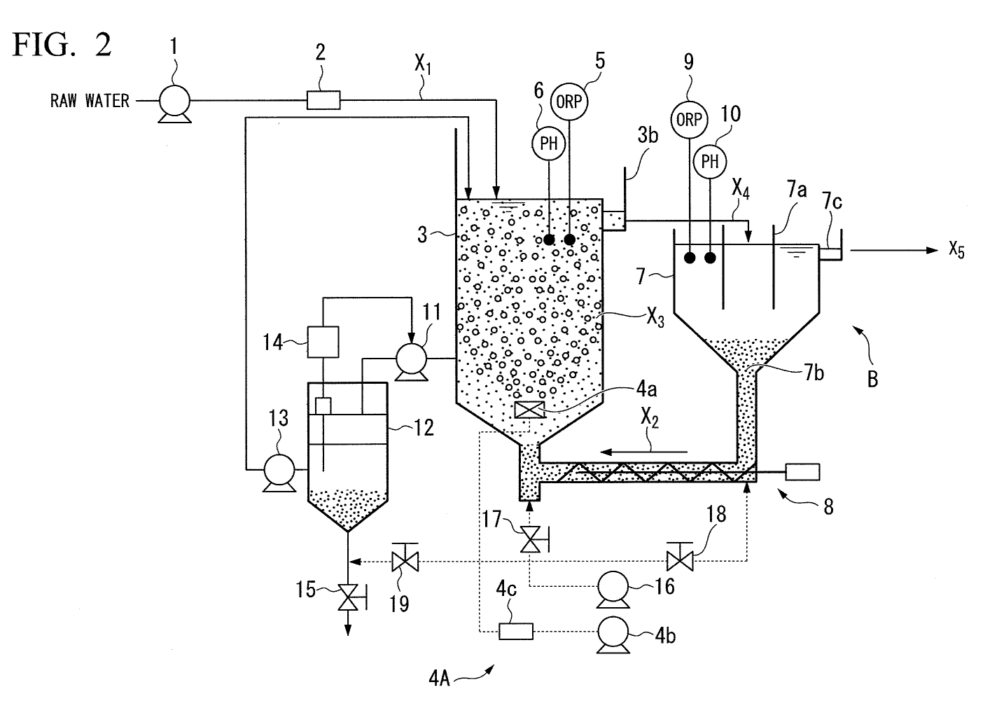

For instance, like a solid-acid-catalyzed saccharification device B shown in FIG. 2, an agitation device 4A may include a diffuser member 4a installed near the bottom portion in a catalytic reaction vessel 3, a gas blower 4b for compressing gas and supplying compressed gas to the diffuser member 4a, and a flow meter 4c for measuring the flow rate of the gas supplied to the diffuser member 4a. As the gas, air or carbon dioxide obtained by a fermentation reaction in the above-mentioned fermentation device or the like may be considered. On the other hand, when air is used, oxygen in air functions as an oxidizer that contributes to the decomposition reaction, so an effect of facilitating the decomposition reaction can be expected.

(2) In the above-mentioned embodiment, the oxidation-reduction electrometer 5 and the pH meter 6 are installed in the catalytic reaction vessel 3, and further the second oxidation-reduction electrometer 9 and the second pH meter 10 are installed in the catalyst separation vessel 7. However, the second oxidation-reduction electrometer 9 and the second pH meter 10 may be omitted as necessary.

(3) In the above-mentioned embodiment, the decomposition reaction in the catalytic reaction vessel 3, the property of the product and the activity of the solid-acid catalyst X2 are evaluated based on the respective measurement values of the oxidation-reduction electrometer 5, the pH meter 6, the second oxidation-reduction electrometer 9 and the second pH meter 10, but no control is performed using the results of such evaluation. However, the operation state of solid-acid-catalyzed saccharification devices A and B may be changed by controlling the controlled equipment such as the raw water-supplying pump 1 or the like based on the evaluation results. For instance, when the decomposition reaction in the catalytic reaction vessel 3 is evaluated as being bad, maintaining the property of the product in a desired state by limiting the feed amount of the raw water X1 to the catalytic reaction vessel 3, lowering the rotation number of the raw water-supplying pump 1 and prolonging the retention time of the polysaccharide in the catalytic reaction vessel 3 may be considered.

### INDUSTRIAL APPLICABILITY

According to the present invention, it is possible to accurately follow the state of monosaccharification reaction of the polysaccharide using the solid-acid catalyst.

### DESCRIPTION OF REFERENCE NUMERALS

A, B: solid-acid-catalyzed saccharification device

1: raw water-supplying pump

2: flow meter

3: catalytic reaction vessel

4, 4A: agitation device

5: oxidation-reduction electrometer

6: pH meter

7: catalyst separation vessel

8: catalyst conveying device

9: second oxidation-reduction electrometer

10: second pH meter

11: catalyst recovery pump

12: catalyst recovery vessel

13: solution-conveying pump

14: float switch

15: catalyst discharge valve

16: blockage-preventing gas blower

17-19: on/off valve

1. A solid-acid-catalyzed saccharification device comprising:
a catalytic reaction vessel configured to contain a polysaccharide feedstock with water and a solid-acid catalyst as a liquid mixture to monosaccharify a polysaccharide using the solid-acid catalyst;
an agitation device configured to agitate the liquid mixture in the catalytic reaction vessel;
an oxidation-reduction electrometer configured to measure a redox potential of the liquid mixture in the catalytic reaction vessel; and
a pH meter configured to measure the pH of the liquid mixture in the catalytic reaction vessel.

2. The solid-acid-catalyzed saccharification device according to claim 1, comprising:
a catalyst separation vessel configured to separate the solid-acid catalyst from a treated solution received from the catalytic reaction vessel;
a catalyst conveying device configured to supply the solid-acid catalyst discharged from the catalyst separation vessel to the catalytic reaction vessel;
a second oxidation-reduction electrometer configured to measure a redox potential of a solution from which the solid-acid catalyst in the treated solution is separated in the catalyst separation vessel; and
a second pH meter configured to measure the pH of the solution from which the solid-acid catalyst in the treated solution is separated in the catalyst separation vessel.

3. The solid-acid-catalyzed saccharification device according to claim 1, wherein the agitation device agitates the solution to be treated by rotating a paddle immersed in the liquid mixture.

4. The solid-acid-catalyzed saccharification device according to claim 1, wherein the agitation device agitates the solution to be treated by blowing gas into the liquid mixture.

5. A solid-acid-catalyzed saccharification method comprising:
measuring a redox potential and a pH of a liquid mixture of a solution to be treated and a solid-acid catalyst at the time of monosaccharification of a polysaccharide by acting the solid-acid catalyst on the solution to be treated including water and a polysaccharide feedstock; and
evaluating a monosaccharification state based on the redox potential and the pH.

6. The solid-acid-catalyzed saccharification method according to claim 5, comprising:
measuring a redox potential and a pH of a solution from which the solid-acid catalyst in the treated solution is separated; and
evaluating a state of the solid-acid catalyst based on the redox potential and the pH.

7. The solid-acid-catalyzed saccharification device according to claim 2, wherein the agitation device agitates the solution to be treated by rotating a paddle immersed in the liquid mixture.

8. The solid-acid-catalyzed saccharification device according to claim 2, wherein the agitation device agitates the solution to be treated by blowing gas into the liquid mixture.
